(19) United States
(12) Patent Application Publication
(10) Pub. No.: US 2004/0148257 A1
(43) Pub. Date: Jul. 29, 2004

(54) Methods and systems for retrieving billing and service records

(76) Inventor: Cesar Garcia, Miami, FL (US)

Correspondence Address: Scott P. Zimmerman, P.O. Box 3822, Cary, NC, 27519, US

(21) Appl. No.: 10/353,387

(22) Filed: Jan. 28, 2003

(51) Int. Cl. G06F 17/60

(52) U.S. Cl. 705/40

(57) ABSTRACT

Methods and systems are disclosed for retrieving a customer's billing and service records regarding telecommunications services. One method includes receiving an inquiry from the customer regarding local telephone service, long distance service, paging service, data service, mobile communications service, and/or customer premise equipment. The customer's billing and service records are retrieved and presented at a single computer system. The billing and service records describe all of the telecommunications services the customer receives from a telecommunications service provider.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but the copyright owner otherwise reserves all copyrights whatsoever.

### BACKGROUND OF THE INVENTION

1. Field of the Invention

This invention generally relates to computers and to computer networks and, more particularly, to methods and systems for retrieving billing and service records for all of the telecommunications services a customer receives from a telecommunications service provider.

2. Description of the Related Art

A customer representative for a telecommunications service provider is at the “front line” when dealing with customers. When a customer calls to inquire about his/her telecommunications service, the customer representative must have access to the customer's various accounts. The customer may subscribe to many telecommunications services from a single service provider, and the customer representative should be able to access all these records. The customer, for example, may subscribe to local telephone service, long distance telephone service, cellular/mobile service, Internet-access service, cable service, and still other services. The customer may call to inquire about any of these services, so the customer representative should have access to all of the customer's billing and service records to adequately resolve any customer issues.

The problem, however, is that a single customer representative currently cannot access all of a customer's records. Although the customer may subscribe to local telephone service, long distance telephone service, cellular/mobile service, Internet-access service, and even other services, each service has a different billing and record system. Because each service has a different system, a single customer representative is usually not able to address the customer's concerns. If the customer calls to inquire about Internet access service, the customer speaks with a customer representative having access to Internet-access billing and service records. If the customer also wants to inquire about local and/or long distance telephone service, the customer is typically transferred to another customer representative with access to those billing and service records. Many times a customer must speak with three and even four different customer representatives to resolve an issue.

Even if the customer only has an inquiry about a single service, the customer representative may still have difficulty accessing the customer's records. If the customer calls to inquire about plain old telephone service, for example, the customer representative may not be able to locate all of the customer's billing and service records. This difficulty is usually because the current records system treats each telephone number as a separate account. If the customer has five telephone lines, each telephone line is a separate account. Should the customer request a new phone number, the old account, for the old phone number, gets closed and then reopened under a new account number. When the customer changes addresses, and thus requires a new phone number, the customer's accounts get closed and then reopened under new numbers. Because the same customer, even a customer for many years, may have many opened and closed accounts, the customer representative may have difficulty identifying that customer and locating the customer's previous addresses and previous phone numbers. The customer representative often must “back track” and determine how many times that customer has moved or how many times that customer has changed numbers.

These difficulties in accessing the customer's billing and service records often bewilder the customer and frustrate the customer representative. The customer representative often requires minutes, or even upwards of an hour, to locate a customer's billing and service records. The customer, however, often cannot understand why the customer representative cannot determine what happened with their account, where is that account, or to whom a bill is sent. The customer representative often bears the brunt of the customer's frustrations. Even if the customer may benefit from added or different services, the customer representative does not have that information readily or easily available on the computer screen. If the customer representative could quickly and easily view all of the customer's accounts, the customer representative could more easily sell services and features to that customer. The customer representative could also more easily inform the customer of bills, the history of those bills, as well as the collection of debts.

There is, accordingly, a need in the art for improved billing and service record keeping, a need for improved accessing of a customer's billing and service records, and a need for presenting all of a customer's billing and service records to a single customer representative.

### BRIEF SUMMARY OF THE INVENTION

The aforementioned problems are reduced by a Negotiating Module. The Negotiating Module comprises methods, computer programs, and computer systems that retrieve billing and service records for all of the telecommunications services a customer receives from a telecommunications service provider. These billing and service records are then presented at a single computer system. Because the customer may receive various telecommunications services from a single service provider, the Negotiating Module of this invention “negotiates” these various billing and recording systems to assemble a single, unified record. A user at the computer system, such as a customer representative, may thus view all of the telecommunications services the customer receives from the telecommunications service provider. That is, the computer user can quickly access and view the customer's local telephone bill and service records, long distance telephone bill and service records, paging service bill and records, data/Internet service bill and records, mobile communications service bill and records, cable bill and service records, and/or the customer's premise equipment. The computer user, in short, may view all of the telecommunications services the customer receives from the telecommunications service provider. Because the computer user has access to all of the customer's telecommunications services, the computer user functions as a single, unified source for initiating service changes, for initiating repairs, and for simply answering questions. The computer user may quickly access and view the customer's records, make changes to these records, and, thus, quickly resolve the customer's inquiry.

An embodiment of this invention describes a method for retrieving a telecommunications customer's billing and service records. An inquiry is received from the customer, and the inquiry regards telecommunications services the customer receives from a telecommunications service provider. These telecommunications services could include at least one of local telephone service, long distance service, paging service, data service, mobile communications service, cable service, customer premise equipment the customer rents or leases, and/or customer premise equipment installed at the customer's premises. The customer's billing and service records regarding the customer's telecommunications services are retrieved. The method then presents the customer's billing and service records at a single computer system, and the billing and service records describe all of the telecommunications services the customer receives from the telecommunications service provider.

Another embodiment of this invention describes a system. This system has a Negotiating Module stored in, or on, a memory device and a processor communicating with the memory device. The Negotiating Module communicates with a data network and requests a customer's billing and service records regarding all of the telecommunications services the customer receives from a telecommunications service provider. These telecommunications services could include local telephone service, long distance service, paging service, data service, mobile communications service, cable service, customer premise equipment the customer rents or leases, and/or customer premise equipment installed at the customer's premises. The Negotiating Module assembles the billing and service records for presentation at a single computer system.

Still another embodiment of this invention describes a computer program product. This computer program product has a Negotiating Module stored on a computer-readable medium. The Negotiating Module communicates with a data network and requests a customer's billing and service records regarding all of the telecommunications services the customer receives from a telecommunications service provider. These telecommunications services could include local telephone service, long distance service, paging service, data service, mobile communications service, cable service, customer premise equipment the customer rents or leases, and/or customer premise equipment installed at the customer's premises. The Negotiating Module assembles the billing and service records for presentation at a single computer system.

### BRIEF DESCRIPTION OF THE SEVERAL VIEWS OF THE DRAWINGS

These and other features, aspects, and advantages of the present invention are better understood when the following Detailed Description of the Invention is read with reference to the accompanying drawings, wherein:

FIGS. 1 and 2 depict possible operating environments for an embodiment of this invention;

FIG. 3 is a schematic showing a billing and service record assembled by this invention;

FIG. 4 is a block diagram illustrating another embodiment of this invention;

FIG. 5 is a block diagram illustrating still another embodiment of this invention;

FIG. 6 is a schematic showing a graphical user interface for this invention;

FIGS. 7 and 8 are block diagrams illustrating other embodiments of the Negotiating Module 20; and

FIGS. 9 and 10 are flowcharts describing a method for retrieving a telecommunications customer's billing and service records.

### DETAILED DESCRIPTION OF THE INVENTION

This invention now will be described more fully hereinafter with reference to the accompanying drawings, in which exemplary embodiments are shown. This invention may, however, be embodied in many different forms and should not be construed as limited to the embodiments set forth herein; rather, these embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (e.g., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

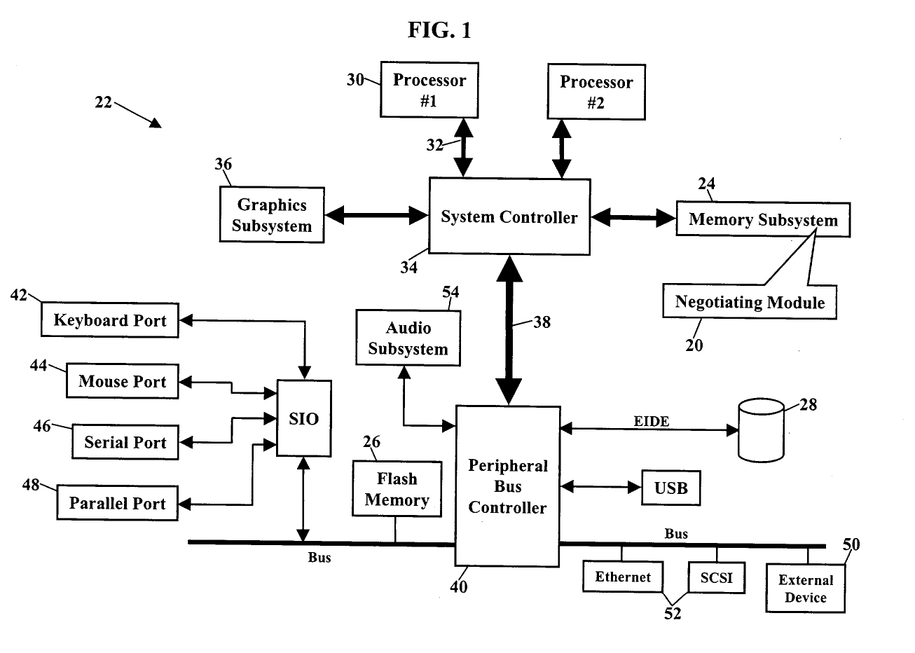

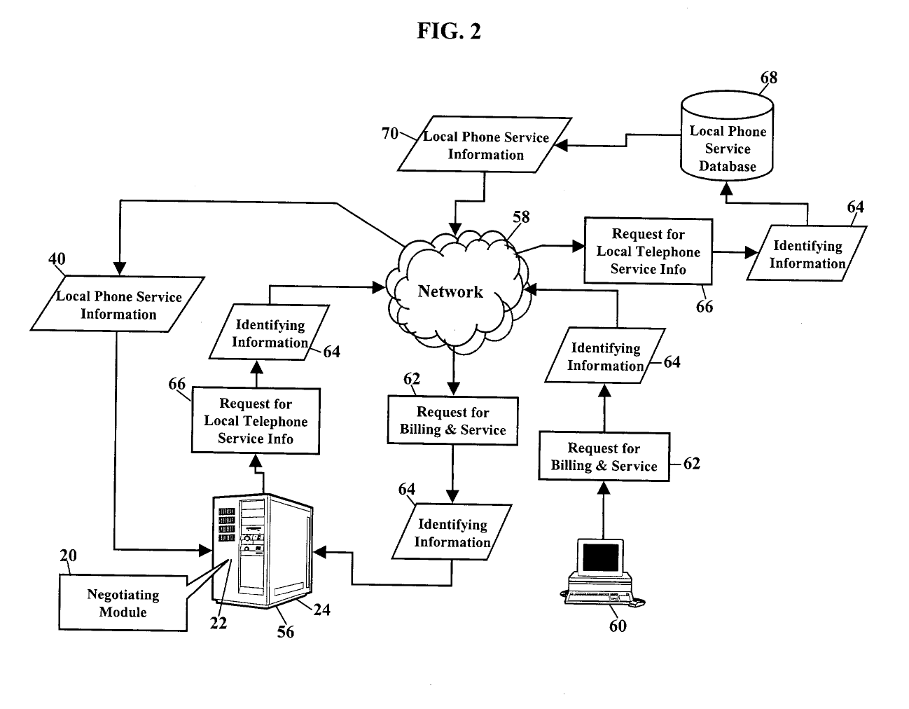

FIGS. 1 and 2 depict possible operating environments for an embodiment of the present invention. This embodiment of a Negotiating Module 20 comprises methods, computer programs, and computer program products that retrieve billing and service records for all of the telecommunications services a customer receives from a telecommunications service provider. These billing and service records are then presented at a single computer system. A user at the computer system, such as a customer representative, may then quickly access and view the customer's local telephone bill and service records, long distance telephone bill and service records, paging service bill and service records, data/Internet service bill and service records, cellular bill and service records, cable service bill and service records, the customer's premise equipment, and/or any other telecommunications services. As those of ordinary skill in the art of computer programming recognize, computer processes/programs are depicted as process and symbolic representations of computer operations. Computer components, such as a central processor, memory devices, and display devices, execute these computer operations. The computer operations include manipulation of data bits by the central processor, and the memory devices maintain the data bits in data structures. The process and symbolic representations are understood, by those skilled in the art of computer programming, to convey the discoveries in the art.

FIG. 1 is a block diagram showing the Negotiating Module 20 residing in a computer system 22. The Negotiating Module 20 operates within a system memory device. The Negotiating Module 20, for example, is shown residing in a memory subsystem 24. The Negotiating Module 20, however, could also reside in flash memory 26 or peripheral storage device 28. The computer system 22 also has one or more central processors 30 executing an operating system. The operating system, as is well known, has a set of instructions that control the internal functions of the computer system 22. A system bus 32 communicates signals, such as data signals, control signals, and address signals, between the central processor 30 and a system controller 34 (typically called a “Northbridge”). The system controller 34 provides a bridging function between the one or more central processors 30, a graphics subsystem 36, the memory subsystem 24, and a PCI (Peripheral Controller Interface) bus 38. The PCI bus 38 is controlled by a Peripheral Bus Controller 40. The Peripheral Bus Controller 40 (typically called a “Southbridge”) is an integrated circuit that serves as an input/output hub for various peripheral ports. These peripheral ports could include, for example, a keyboard port 42, a mouse port 44, a serial port 46 and/or a parallel port 48 for a video display unit, one or more external device ports 50, and networking ports 52 (such as SCSI or Ethernet). The Peripheral Bus Controller 40 could also include an audio subsystem 54. Those of ordinary skill in the art understand that the program, processes, methods, and systems described in this patent are not limited to any particular computer system or computer hardware.

Those of ordinary skill in the art also understand the central processor 30 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described in this patent are not limited to any particular manufacturer's central processor.

The preferred operating system is the UNIX® operating system (UNIX® is a registered trademark of the Open Source Group, www.opensource.org). Other UNIX-based operating systems, however, are also suitable, such as LINUX® or a RED HAT® LINUX-based system (LINUX® is a registered trademark of Linus Torvalds, and RED HAT® is a registered trademark of Red Hat, Inc., Research Triangle Park, N.C., 1-888-733-4281, www.redhat.com). Other operating systems, however, are also suitable. Such other operating systems would include a WINDOWS-based operating system (WINDOWS® is a registered trademark of Microsoft Corporation, One Microsoft Way, Redmond Wash. 98052-6399, 425.882.8080, www.Microsoft.com). and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

The system memory device (shown as memory subsystem 24, flash memory 26, or peripheral storage device 28) may also contain an application program. The application program cooperates with the operating system and with a video display unit (via the serial port 46 and/or the parallel port 48) to provide a Graphical User Interface (GUT). The Graphical User Interface typically includes a combination of signals communicated along the keyboard port 42 and the mouse port 44. The Graphical User Interface provides a convenient visual and/or audible interface with a user of the computer system 22.

FIG. 2 is a schematic illustrating a further operating environment for the Negotiating Module 20. As FIG. 2 shows, the Negotiating Module 20 is a computer program that operates within the memory subsystem 24 of the computer system 22. (The Negotiating Module 20, however, could also reside in flash memory 26 or peripheral storage device 28, shown, respectively, as reference numerals 26 and 28 in FIG. 1. The Negotiating Module 20 could also be subdivided between two or more computer systems.) The computer system 22 is visually shown as a server 56. The Negotiating Module 20 acquires information from a data network 58 using a data-transfer protocol (such as TCP/IP). The Negotiating Module 20 then uses this information to assemble a customer's billing and service records.

The Negotiating Module 20 interfaces with one or more computer databases. As FIG. 2 shows, a user at a user computer 60 issues a request 62 for a telecommunications customer's billing and service records. The user can be a customer representative, a service technician, a manager, and/or any other person having authority to access the customer's billing and service records. The request 62 for the billing and service records is communicated over the network 58 to the Negotiating Module 20 using TCP/IP protocol or any other computer communications protocol. The request 62 for the billing and service records also contains identifying information 64 for the customer. This identifying information 64 could be the customer's telephone number, the customer's social security number, the customer's address, or any other means of identifying the customer. The Negotiating Module 20 receives the request 62 for the billing and service records and then requests information to assemble the billing and service records. Because the customer may subscribe to various telecommunications services from a single service provider, the Negotiating Module 20 “negotiates” the various billing and recording systems to assemble a single, unified record. The Negotiating Module 20 can issue requests in whatever format a particular system may require.

The Negotiating Module 20, for example, retrieves Local Telephone service information. The Negotiating Module 20 issues a request 66 for the Local Telephone service information. This request 66 for the Local Telephone service information includes the customer's identifying information 64 and is communicated over the network 58. The request 66 for the Local Telephone service information, and the customer's identifying information 64, is received by a Local Telephone service database 68. The Local Telephone service database 68 stores information relating to the customer's local telephone bills and service records. The Local Telephone service database 68 could store, for example, the number of minutes/hours the customer utilized local telephone service, the charges for those local calls, past billing cycles and charges, and even a log of local telephone calls made by the customer. The Local Telephone service database 68 retrieves Local Telephone service information 70 associated with the customer's identifying information 64. The Local Telephone service information 70 is then communicated over the network 58 to the Negotiating Module 20. The Negotiating Module 20 acquires the Local Telephone service information 70 and then uses the Local Telephone service information 70 to construct customer's billing and service records.

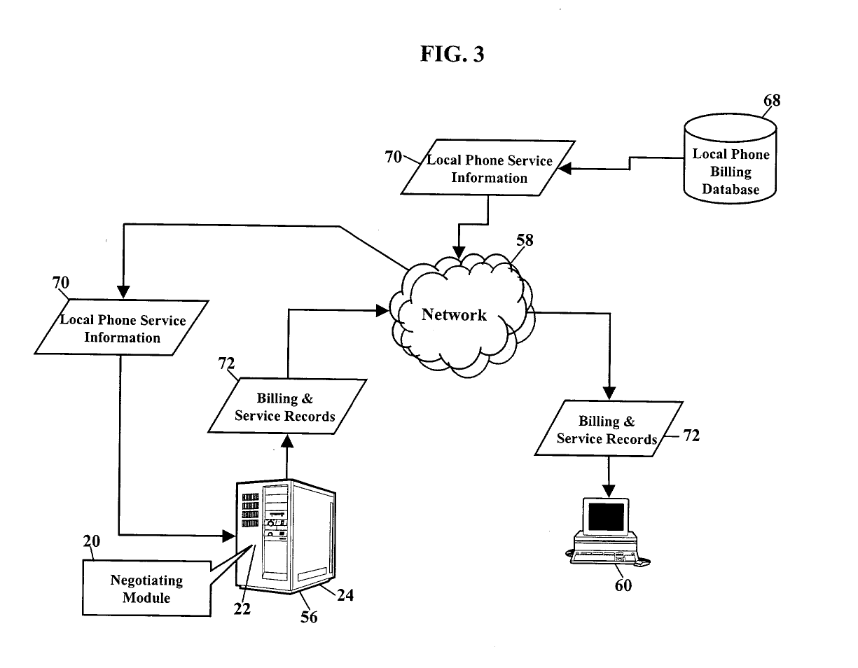

FIG. 3 is a schematic showing a billing and service record 72 assembled by this invention. After the Negotiating Module 20 acquires the Local Telephone service information 70, the billing and service record 72 is assembled. The Negotiating Module 20 uses the Local Telephone service information 70, and other acquired information, to construct the billing and service record 72. The billing and service record 72 is then communicated over the network 58 to the user at the single user computer 60.

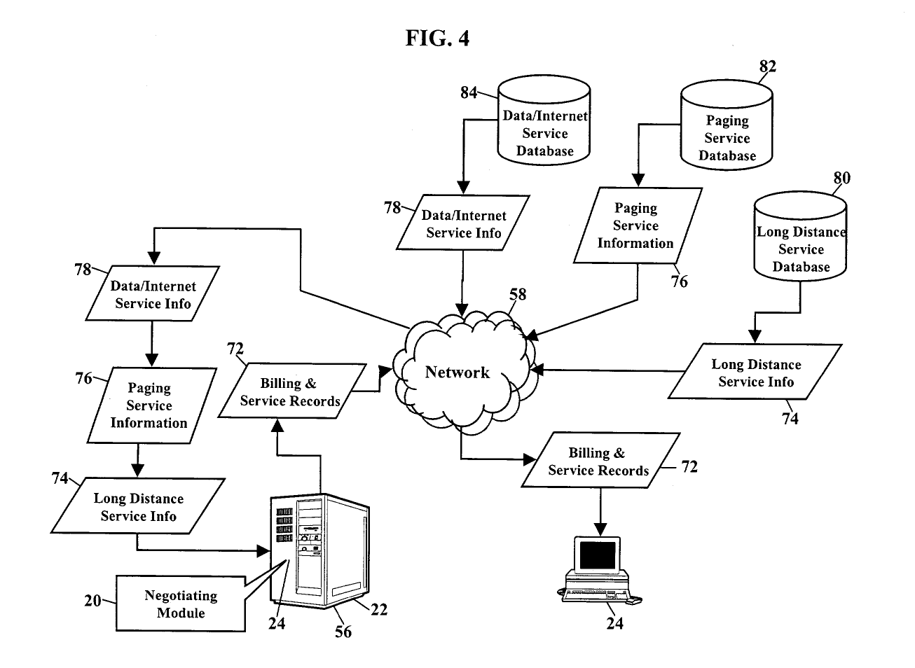

FIG. 4 is a block diagram illustrating another embodiment of the Negotiating Module 20. FIG. 4 shows the Negotiating module 20 acquiring additional information when assembling the billing and service record 72. The Negotiating module 20, for example, may acquire, via the network 58, Long Distance service information 74, paging service information 76, and data/Internet service information 78. The Negotiating module 20 could also acquire any other information regarding other telecommunications services. The Long Distance service information 74 is stored in a Long Distance service database 80, and the Long Distance service information 74 describes information relating to the customer's long distance telephone bills and records. The Long Distance service information 74 describes, for example, the number of minutes/hours the customer utilized long distance telephone service, the charges for those calls, past billing cycles and charges, and even a log of long distance telephone calls made by the customer. The paging service information 76 is stored in a paging service database 82, and the paging service information 76 describes information relating to the customer's paging service bills and records. The paging service information 76 could describe the number of minutes/hours the customer utilized the paging service, the charges for that paging service, past billing cycles, and a log of page communications initiated and/or received by the customer. The data/Internet service information 78 is stored in a Data/Internet service database 84, and the data/Internet service information 78 describes information relating to the customer's data networking usage and billing records. The data/Internet service information 78 could describe, for example, the number of minutes/hours the customer accessed a data network (such as the Internet distributed computing network), the charges for that access, past billing cycles and charges, and even Internet Protocol addresses accessed by the customer. The Negotiating module 20 could also acquire other telecommunications-related information, such as cable service information describing the billing and service records for cable service received from the telecommunications service provider. The Negotiating Module 20 uses all this information to construct the billing and service record 72. The billing and service record 72 is then communicated over the network 58 to the user at the single user computer 60.

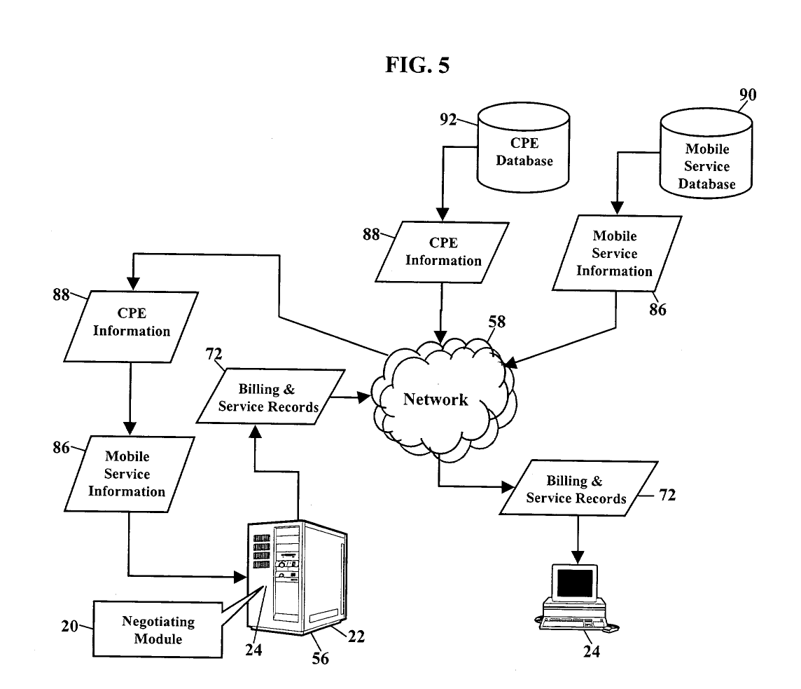

FIG. 5 is a block diagram illustrating another embodiment of the Negotiating Module 20. Here the Negotiating module 20 acquires, via the network 58, mobile service information 86 and the customer's premise equipment (CPE) information 88. The mobile service information 86 is stored in a mobile service database 92 and describes information relating to the customer's use of one or more wireless devices or wireless communications services. This mobile communications service could include mobile telephone service, wireless data computing or access services, text messaging services, and other mobile/wireless services. Some examples of these mobile communications services include wireless/cellular/satellite telephone service and data service and wireless data networking and access (such as the Industrial, Scientific, & Medical band and/or the I.E.E.E. 802.11 family of wireless standards). The mobile service information 86 could describe, for example, the number of minutes/hours the customer accessed these mobile/wireless services, the charges for that access, past billing cycles and charges, and even a log of Internet Protocol addresses accessed by the customer.

The customer's premise equipment (CPE) information 88 is stored in a customer's premise equipment (CPE) database 92. The customer's premise equipment (CPE) information 88 is an inventory of telephone equipment owned, leased, and/or rented by the customer. This customer's premise equipment information 88 could also include information relating to jacks and other terminals and equipment installed at the customer's premises. While this customer's premise equipment information 88 may be gathered anew from existing telephone records, some customers may have their customer's premise equipment information 88 already maintained in a switch system database. This switch system database maintains an inventory of telephone equipment and telephone numbers for many customers. One such switch system database is the TELCORDIA™ SWITCH™ system (TELCORDIA™ and SWITCH™ are trademarks of Telcordia Technologies, Inc., 445 South St., Morristown N.J. 07960, www.telcordia.com). The Negotiating Module 20 uses all this information to construct the billing and service record 72. The billing and service record 72 is then communicated over the network 58 to the user at the single user computer 60.

The billing and service record 72 is then presented at a single computer system. As FIGS. 2-5 illustrate, the billing and service record 72 is presented to the customer representative, or other authorized user, at the single user computer 60. The billing and service record 72 describes all of the telecommunications services the customer receives from the telecommunications service provider. Although the billing and service record 72 is preferably visually displayed, the billing and service record 72 may also be audibly presented at the user computer 60. The customer's billing and service record 72 is visually displayed to the user, and the user is permitted to make changes to the customer's billing and service records 72. Changes to the customer's billing and service records may thus originate from the user computer 60. The user, such as the customer representative, may then have authorization to credit the customer's account, make service changes, and otherwise resolve any issues that initiated the customer's inquiry.

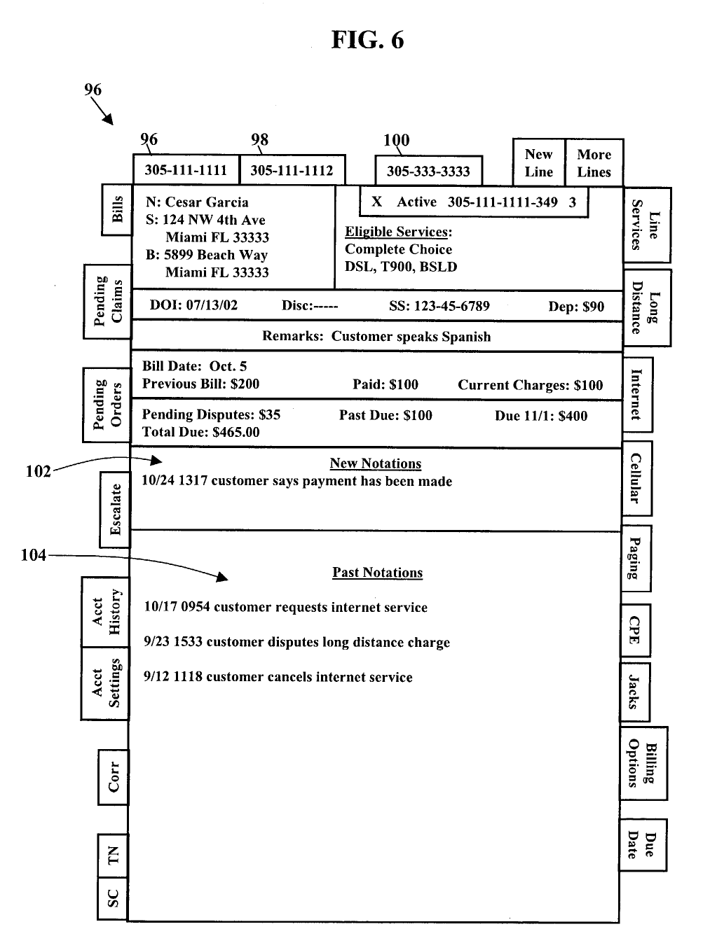

FIG. 6 is a schematic showing a graphical user interface 94. This graphical user interface 94 is a representation of the billing and service record (shown as reference numeral 72 in FIGS. 2-5) for all of the telecommunications services the customer receives from a telecommunications service provider. This graphical user interface 94 also permits the user, such as the customer representative, to navigate between the customer's telecommunications services to make service changes and to otherwise resolve any issues. The Negotiating Module (shown as reference numeral 20 in FIGS. 1-5) assembles the disparate, individual billing and service records (e.g., the Local Telephone service information, the Long Distance service information, the paging service information, the data/Internet service information, the mobile service information, and the customer's premise equipment information). The Negotiating Module then communicates the unified billing and service record to the user at the single user computer (shown as reference numeral 60 in FIGS. 2-5). Because the Negotiating Module acquires and assembles a single billing and service record for all of the customer's telecommunications services, a user at the user computer (such as a customer representative) may then quickly access and view the customer's unified billing and service records.

While FIG. 6 shows the graphical user interface 94, many details of the graphical user interface 94 are not pertinent to the disclosure of this invention. These many details are also not necessary for an understanding of this invention. Suffice it to say the customer's billing and service records can be thought of as a single folder for the customer. That one folder contains tabs that allow the computer user (e.g., the customer representative) to quickly navigate amongst all the customer's telecommunications services. As FIG. 6 shows, the upper left hand corner of the graphical user interface 94 contains a tab for each telephone line that customer has with the telecommunications service provider. Here the customer, Cesar Garcia, has three telephone lines and, thus, three corresponding tabs 96, 98, and 100. As the computer user clicks each tab, the computer user may easily switch from one account to another, thus seeing eligible services or services that the customer may need. With one click of one tab, the computer user may issue a change on a telephone line or issue different changes on several telephone lines at one time. Because this invention acquires and assembles a single billing and service record for all of the customer's telecommunications services, this invention reduces the amount of time that the user (e.g., the customer representative) spends opening and closing separate screens for separate accounts. This single, unified billing and service record provides a single, big picture of all of the customer's telecommunications services.

Although many details of the graphical user interface 94 are not pertinent to this invention, the notations for the graphical user interface 94 are pertinent. As FIG. 6 shows, the graphical user interface 94 includes a “New Notations” field 102 and a “Past Notations” field 104. The single, unified billing and service record displays both the “New Notations” field 102 and the “Past Notations” field 104 throughout the customer's inquiry. The “New Notations” field 102 allows a computer user at the single computer system to add notations describing the customer's inquiry regarding any of the telecommunications services the customer receives from the telecommunications service provider. Regardless which telecommunications service the user (e.g., the customer representative) is viewing, the “New Notations” field 102 is always available to the user to note the customer's inquiry and the actions taken. Thus, should the customer inquire about their mobile service and about their data service, any notations regarding either inquiry are displayed to the computer user. The “Past Notations” field 104, similarly, is displayed throughout the customer's inquiry, and the “Past Notations” field 104 describes at least some of the customer's past inquiries regarding any of the customer's telecommunications services received from the telecommunications service provider. So, even if the customer inquires about their mobile communications service, the computer user can view previous notations regarding any past inquiry. Because current and past notations are available to the computer user, it is pertinent then to discuss storing and retrieving the notations.

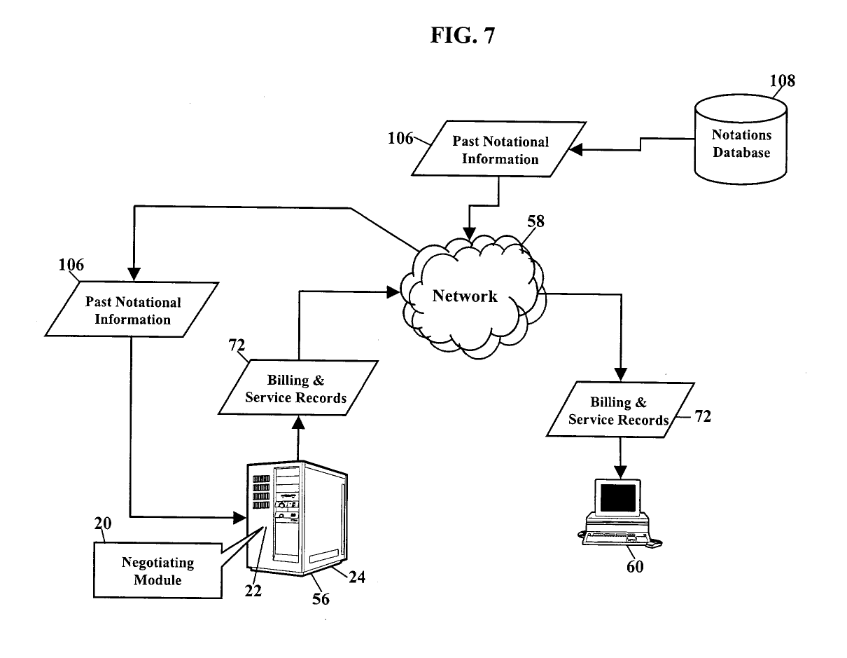

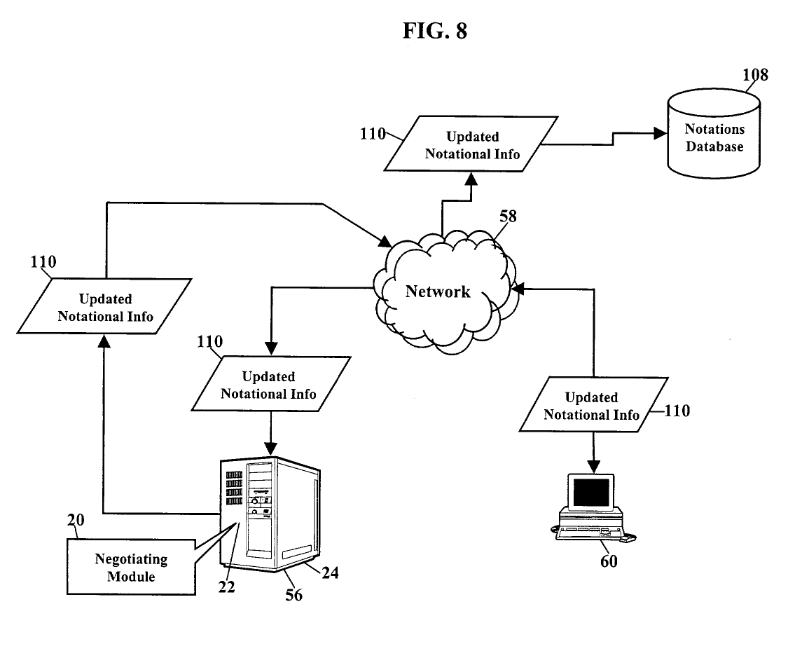

FIGS. 7 and 8, then, are block diagrams illustrating other embodiments of the Negotiating Module 20. FIG. 7 shows the billing and service record 72 may comprise past notational information 106. While the Negotiating Module 20 acquires information to construct the billing and service record 72, the Negotiating Module 20 also acquires past notational information 106. This past notational information 106 is retrieved from a notations database 108. The notations database 108 stores previous notations of the customer's past inquiries regarding any of the customer's telecommunications services. The Negotiating Module 20 uses the past notational information 106, and other acquired information, to construct the billing and service record 72. The billing and service record 72 is then communicated over the network 58 to the user at the single user computer 60.

FIG. 8 is a schematic showing the Negotiating Module 20 may acquire updated notational information 110. This updated notational information 110 describes new notations of the customer's current or present inquiry regarding the customer's telecommunications services. The updated notational information 110 is communicated from the user computer 60, via the data network 58, to the Negotiating Module 20. The Negotiating Module 20 then communicates the updated notational information 110 to the notations database 108 via the data network 58. The notations database 108 stores the updated notational information 110, whereupon the updated notational information 110 is merged with the past notational information (shown as reference numeral 106 in FIG. 7) for presentation during a later customer inquiry.

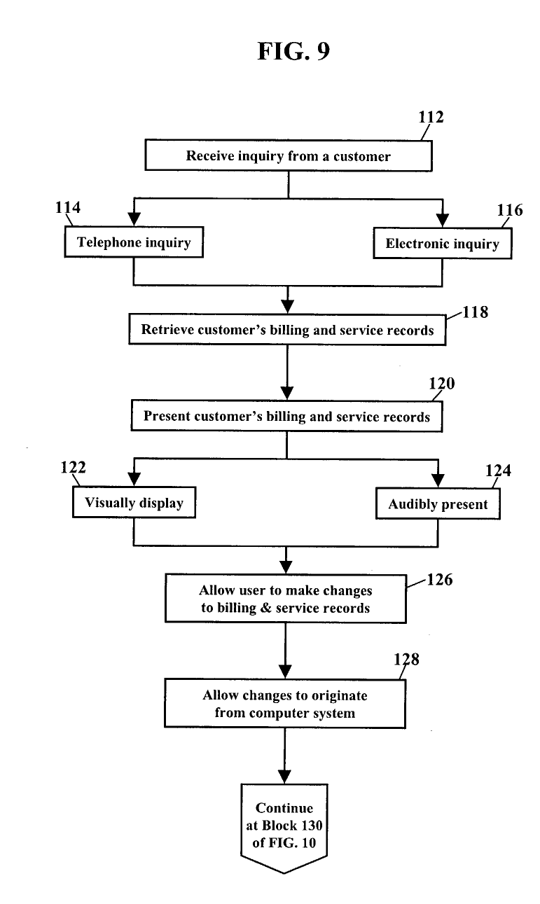

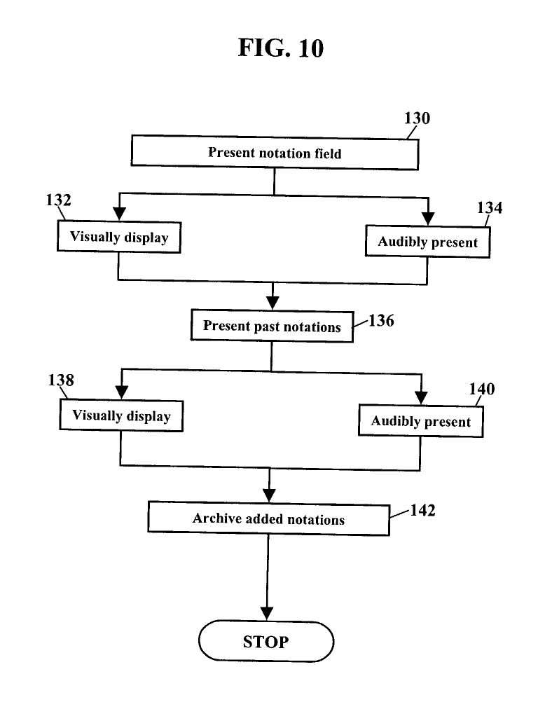

FIGS. 9 and 10 are flowcharts describing a method for retrieving a telecommunications customer's billing and service records. An inquiry is received from a customer (Block 112). While the inquiry can be from any medium, the inquiry is most commonly a telephone inquiry (Block 114) or an electronic inquiry (e.g., an email inquiry or a digitally-recorded inquiry) (Block 116). The inquiry regards telecommunications services the customer receives from a telecommunications service provider. These telecommunications services include at least two of local telephone service, long distance service, paging service, data service, mobile communications service, and customer premise equipment. The customer's billing and service records are retrieved (Block 118) and presented at a single computer system (Block 120). The billing and service records describe all of the telecommunications services the customer receives from the telecommunications service provider. The presentation of the customer's billing and service records may be by visual display (Block 122) and/or by audible presentation (Block 124). A user may be allowed to make changes to the customer's billing and service records (Block 126), and changes to the customer's billing and service records may also originate from the single computer system (Block 128). Any changes that originate from the single computer system may be from automated voice responses and/or Dual Tone Multi-Frequency (DTMF) keypad entries. As those of ordinary skill in the art understand, automated voice responses may be implemented using many techniques, such as a VoiceXML gateway. The VoiceXML gateway enables access to, and modification of, web-based information through a normal voice interface. VoiceXML, in addition, provides for automatic speech recognition and/or text-to-speech communication. As those of ordinary skill in the art also understand, DTMF signaling is a means of transferring information from the customer through the use of in-band audio tones. Each digit of information is assigned a simultaneous combination of one of a lower group of frequencies and one of a higher group of frequencies to represent each digit or character. The VoiceXML technique, the VoiceXML gateway, and the DTMF technique are known and will not be further described.

The flowchart continues with FIG. 10. Once the customer's billing and service records are retrieved (Block 118) and presented (Block 120), a notation field may also be presented (Block 130). The notation field allows a user at the single computer system to add notations describing the customer's inquiry. The presentation of the notation field may be by visual display (Block 132) and/or by audible presentation (Block 134). Past notations may also be presented (Block 136), with the past notations describing at least some of the customer's past inquiries regarding any of the telecommunications services the customer receives from the telecommunications service provider. The presentation of the past notations may be by visual display (Block 138) and/or by audible presentation (Block 140). The added notations are then archived (Block 142) for later retrieval.

The Negotiating Module (shown as reference numeral 20 in FIGS. 1-8) may be physically embodied on or in a computer-readable medium. This computer-readable medium may include CD-ROM, DVD, tape, cassette, floppy disk, memory card, and large-capacity disk (such as 10MEGA®, ZIP®, JAZZ®, and other large-capacity memory products (10MEGA®, ZIP®, and JAZZ® are registered trademarks of lomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the Negotiating Module to be easily disseminated. A computer program product for retrieving a telecommunications customer's billing and service records comprises the computer-readable medium and the Negotiating Module. The Negotiating Module is stored on the computer-readable medium.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. A method, comprising:
receiving an inquiry from a customer, the inquiry regarding telecommunications services the customer receives from a telecommunications service provider, these telecommunications services including at least two of local telephone service, long distance service, paging service, data service, mobile communications service, and customer premise equipment;
retrieving the customer's billing and service records regarding the customer's telecommunications services; and
presenting the customer's billing and service records at a single computer system, the billing and service records describing all of the telecommunications services the customer receives from the telecommunications service provider.

2. A method according to claim 1, wherein the step of receiving the inquiry from the customer comprises receiving a telephone inquiry.

3. A method according to claim 1, wherein the step of receiving the inquiry from the customer comprises receiving an electronic inquiry.

4. A method according to claim 1, wherein the step of retrieving the customer's billing and service records comprises retrieving the billing and service records from a data network.

5. A method according to claim 1, wherein the step of presenting the customer's billing and service records comprises displaying the customer's billing and service records at the single computer system.

6. A method according to claim 1, wherein the step of presenting the customer's billing and service records comprises displaying the customer's billing and service records to a user at the single computer system.

7. A method according to claim 1, further comprising allowing a user to make changes to the customer's billing and service records.

8. A method according to claim 1, further comprising allowing changes to the customer's billing and service records to originate from the single computer system.

9. A method according to claim 1, further comprising displaying a notation field at the single computer system throughout the customer's inquiry, the notation field allowing a user at the single computer system to add notations describing the customer's inquiry regarding any of the telecommunications services the customer receives from the telecommunications service provider.

10. A method according to claim 1, further comprising archiving notations describing the customer's inquiry regarding any of the telecommunications services the customer receives from the telecommunications service provider

11. A method according to claim 1, further comprising displaying past notations at the single computer system throughout the customer's inquiry, the past notations describing at least some of the customer's past inquiries regarding any of the telecommunications services the customer receives from the telecommunications service provider.

12. A method according to claim 1, further comprising retrieving past notations describing at least some of the customer's past inquiries regarding any of the telecommunications services the customer receives from the telecommunications service provider

13. A system, comprising:
a Negotiating Module stored in a memory device, the Negotiating Module communicating with a data network and requesting a customer's billing and service records regarding all of the telecommunications services the customer receives from a telecommunications service provider, these telecommunications services including at least two of local telephone service, long distance service, paging service, data service, mobile communications service, and customer premise equipment, the Negotiating Module assembling the billing and service records for presentation at a single computer system; and
a processor communicating with the memory device.

14. A system according to claim 1, further comprising a display device for displaying the customer's billing and service records.

15. A computer program product, comprising:
a computer-readable medium; and
a Negotiating Module stored on the computer-readable medium, the Negotiating Module communicating with a data network and requesting a customer's billing and service records regarding all of the telecommunications services the customer receives from a telecommunications service provider, these telecommunications services including at least two of local telephone service, long distance service, paging service, data service, mobile communications service, and customer premise equipment, the Negotiating Module then assembling the billing and service records for presentation at a single computer system.
